(19) United States
(12) Patent Application Publication
(10) Pub. No.: US 2021/0086719 A1
(43) Pub. Date: Mar. 25, 2021

(54) SIDE AIRBAG DEVICE

(71) Applicant: TOYODA GOSEI CO., LTD., Kiyosu-shi (JP)

(72) Inventors: Shohei OTA, Kiyosu-shi (JP); Koji SHIBAYAMA, Kiyosu-shi (JP)

(21) Appl. No.: 17/023,887

(22) Filed: Sep. 17, 2020

(30) Foreign Application Priority Data
Sep. 25, 2019 (JP) 2019-174314

(51) Int. Cl. B60R 21/231; B60R 21/26; B60R 21/2338; B60R 21/233

(52) U.S. Cl. CPC B60R 21/23138; B60R 21/26; B60R 2021/0048; B60R 21/233; B60R 21/2338

(57) ABSTRACT

A side airbag device includes an airbag that is to be deployed and inflated to correspond to a portion from at least a head portion to a chest portion of the occupant. With a vehicle width direction being taken as a thickness direction, inner surfaces of the airbag in the thickness direction are connected by a tether so that a thickness of the airbag is regulated. The tether partitions an inner portion of the airbag into a first inflation chamber and a second inflation chamber, and has a communication hole through which the first inflation chamber and the second inflation chamber are in communication. When the airbag is inflated, the first inflation chamber corresponds to a rear chest portion of the occupant, and the second inflation chamber corresponds to a front chest portion and the head portion of the occupant. The inflator is disposed in the first inflation chamber.

### CROSS-REFERENCE TO RELATED APPLICATIONS

The present application claims the benefit of priority of Japanese Patent Application No. 2019-174314, filed on Sep. 25, 2019, the content of which is incorporated herein by reference.

### TECHNICAL FIELD

The present invention relates to a side airbag device that is mounted on a vehicle and that protects an occupant from impact of a collision against the vehicle from a lateral side.

### BACKGROUND ART

This type of side airbag device includes an airbag that is to be deployed and inflated between a body side portion of a vehicle and an occupant seated on a seat in a vehicle interior. There is such a side airbag device in which the airbag is deployed and inflated correspondingly to a portion from a head portion to a chest portion of the occupant (see JP-A-2007-320455, for example).

In the above-described side airbag device, although a tether is provided in an inner portion of the airbag, the inner portion of the airbag is configured in a single chamber. Therefore, since pressure produced at the time of inflation of the airbag is substantially uniform as a whole, impact from the airbag received by a head portion of the occupant and impact from the airbag received by the chest portion of the occupant are substantially the same. However, since the head portion of the occupant is weaker than the chest portion with shoulders in resistance against the impact from a lateral side, there is room for improvement in protecting the occupant effectively.

### SUMMARY OF INVENTION

The present invention has been made focusing on such a problem existing in the related art. An object of the present invention is to provide a side airbag device capable of effectively protecting an occupant.

Hereinafter, a device for solving the above-described problem and effects thereof will be described.

A side airbag device for solving the above-described problem is a side airbag device including an airbag that is to be deployed and inflated between a body side portion of a vehicle and an occupant seated on a seat in a vehicle interior under pressure of a gas supplied from an inflator. The airbag is to be deployed and inflated to correspond to a portion from at least a head portion to a chest portion of the occupant. With a vehicle width direction being taken as a thickness direction, inner surfaces of the airbag in the thickness direction are connected by a tether so that a thickness of the airbag is regulated. The tether partitions an inner portion of the airbag into a first inflation chamber and a second inflation chamber, and has a communication hole through which the first inflation chamber and the second inflation chamber are in communication. The first inflation chamber corresponds to a rear chest portion when the airbag is inflated which is a rear side portion of the chest portion of the occupant. The second inflation chamber corresponds to the head portion and a front chest portion, which is a front side portion of the chest portion of the occupant, when the airbag is inflated. The inflator is disposed in the first inflation chamber.

According to this configuration, since the inflator is disposed in the first inflation chamber, the second inflation chamber is lower in pressure than the first inflation chamber when the airbag is inflated. Therefore, impact applied to the occupant from the airbag is smaller in the front chest portion and the head portion having relatively low resistance to impact than in the rear chest portion having relatively high resistance to impact. Accordingly, the front chest portion and the head portion having relatively low resistance to impact can be softly restrained and protected by the airbag as compared with the rear chest portion having relatively high resistance to impact, and thus the occupant can be effectively protected.

In the side airbag device, the airbag is preferably deployed and inflated to correspond to a portion from the head portion to a waist portion of the occupant, and the first inflation chamber is preferably corresponds to the rear chest portion of the occupant and the waist portion of the occupant when the airbag is inflated.

According to this configuration, since the first inflation chamber, in which the pressure is higher than that of the second inflation chamber when the airbag is inflated, corresponds to the rear chest portion and the waist portion having relatively high resistance to impact, it is possible to effectively protect the portion from the head portion to the waist portion of the occupant.

In the side airbag device, the tether preferably has a partition portion that partitions the inner portion of the airbag into the first inflation chamber and the second inflation chamber, and the partition portion preferably includes a first linear portion, which extends in the vehicle front-rear direction and partitions a portion corresponding to the head portion of the occupant in the airbag and a portion corresponding to the rear chest portion of the occupant in the airbag, a second linear portion, which extends in the upper-lower direction and partitions a portion corresponding to the front chest portion of the occupant in the airbag and the portion corresponding to the rear chest portion of the occupant in the airbag, and a curved portion, which extends in a curved manner so as to connect a front end of the first linear portion and an upper end of the second linear portion.

According to this configuration, when the airbag is inflated, a thickness of a portion corresponding to the tether in the airbag is thinner than those of other portions. Therefore, impact applied to the occupant from the airbag is smaller in a portion of the occupant corresponding to the tether than in a portion of the occupant not corresponding to the tether. In this case, in particular, since the curved portion and the second linear portion in the partition portion of the tether correspond to an upper arm of the occupant, a pressing force applied to the front chest portion, which has relatively low resistance to impact, from the upper arm of the occupant due to the impact at the time the airbag is inflated can be reduced.

In the side airbag device, a non-inflation portion not inflating is preferably provided at a position that is in a peripheral edge portion on a front side of the airbag and that faces the curved portion in the vehicle front-rear direction.

According to this configuration, when the airbag is inflated, the portion corresponding to the head portion of the occupant in the airbag can be pulled by the non-inflation portion so that the portion corresponding to the head portion of the occupant in the airbag is not excessively swung in the vehicle width direction, and thus the head portion of the occupant can be appropriately protected.

According to the present invention, an occupant can be effectively protected.

### BRIEF DESCRIPTION OF DRAWINGS

FIG. 1 is a side view illustrating an entire side airbag device at the time when the airbag is inflated.

FIG. 2 is an enlarged cross-sectional view of a periphery of an airbag inside a seatback.

FIG. 3 is a plan view illustrating a positional relationship between a seat and a body side portion in a vehicle.

FIG. 4 is a developed view of an airbag.

FIG. 5 is an enlarged view of an unfolded airbag in a state of not being inflated.

### DESCRIPTION OF EMBODIMENTS

Hereinafter, an embodiment of a side airbag device applied to a vehicle such as an automobile will be described with reference to the drawings.

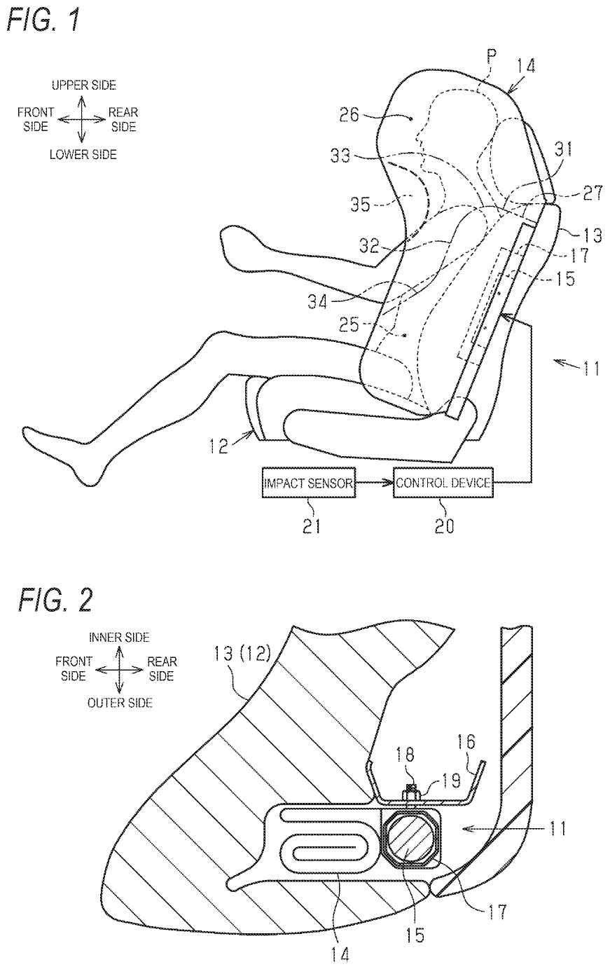

As illustrated in FIG. 1, a side airbag device 11 includes an airbag 14 that is accommodated in a folded state inside a seatback 13 of a seat 12 in a vehicle, and an inflator 15 that supplies an inflation gas to the airbag 14. The inflator 15 is fixed to a frame 16 inside the seatback 13 together with the airbag 14.

As illustrated in FIG. 2, the inflator 15 accommodated inside the seatback 13 is fixed to a retainer 17, which covers a periphery of the inflator 15, by caulking or the like. The retainer 17 is fixed to the frame 16 together with the airbag 14 in a folded state by a bolt 18 and a nut 19. That is, the retainer 17 in a state where the inflator 15 is fixed is fixed to the frame 16 together with the airbag 14.

As illustrated in FIG. 1, the side airbag device 11 includes a control device 20 that controls supply of inflation gas to the airbag 14 from the inflator 15, and an impact sensor 21 that detects a side collision of the vehicle. When impact of the side collision is applied to the vehicle, the impact sensor 21 outputs a detection signal to the control device 20. The control device 20 actuates the inflator 15 to supply inflation gas to the airbag 14 based on the detection signal from the impact sensor 21.

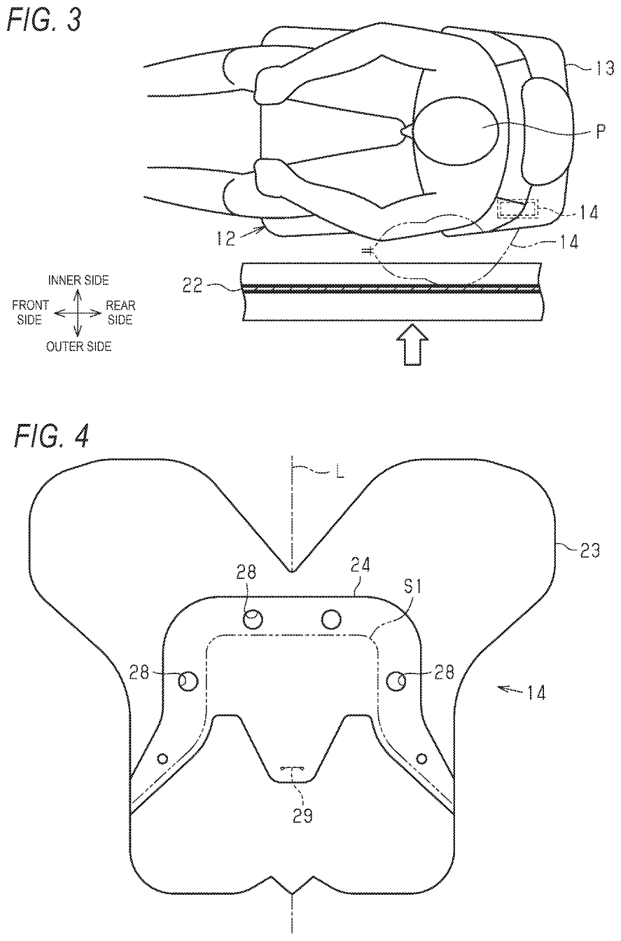

Further, when inflation gas is supplied from the inflator 15 to the airbag 14 in the folded state, the airbag 14 is deployed and inflated under pressure of the gas and pops out forward from the seat back 13, and a portion thereof in the vicinity of the inflator 15 remains in the seatback 13. The airbag 14 popping out from the seatback 13 is deployed toward the front of the vehicle and is inflated between an occupant P seated on the seat 12 in a vehicle interior and a body side portion 22 such as a door and a pillar of the vehicle, as indicated by a two-dot chain line in FIG. 3.

In this case, a size of the airbag 14 in the deployed and inflated state is large enough to protect a portion from the head portion to a waist portion of the occupant P. That is, the airbag 14 is deployed and inflated so as to correspond to the portion from the head portion to the waist portion of the occupant P. Further, in this case, the occupant P seated on the seat 12 in the vehicle interior has a body build same as that of a crash test dummy. This dummy is, for example, an AM50 (model covering 50% of an American adult male) of Worldwide Harmonized Side Impact Dummy (WorldSID).

A white arrow in FIG. 3 indicates a direction in which the impact is applied when the impact is applied to the body side portion 22 due to a side collision of the vehicle.

Next, a configuration of the airbag 14 will be described in detail.

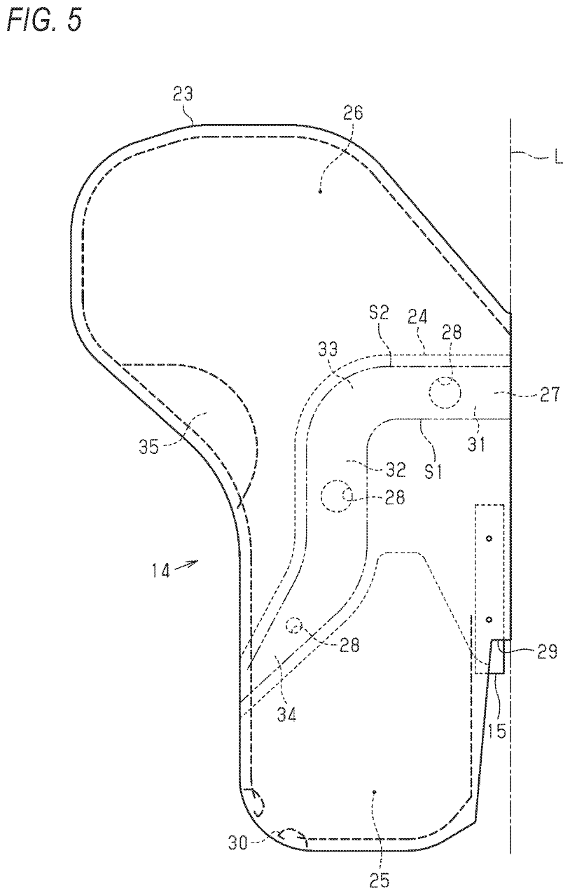

As illustrated in FIGS. 4 and 5, the airbag 14 is formed into a bag shape by sewing a tether 24, which is made of a piece of cloth, on one piece of base fabric 23 along a two-dot chain line indicated by S1, folding the one piece of base fabric 23 together with the tether 24 along a bend line L into two overlapped parts, and then sewing up peripheral edge portions of the two overlapped parts of the base fabric 23.

In this case, two folded and overlapped parts of the tether 24 in the airbag 14 are sewn up along a two-dot chain line indicated by S2 that extends along a peripheral edge portion located above the two-dot chain line indicated by S1. Accordingly, inner surfaces of the airbag 14 in a thickness direction are connected by the tether 24 so that a thickness of the airbag 14 is regulated when the airbag 14 is inflated. The thickness direction of the airbag 14 coincides with a vehicle width direction (left-right direction).

A region of the tether 24 between the two-dot chain line indicated by S1 and the two-dot chain line indicated by S2 is belt-shaped, and serves as a partition portion 27 that partitions an inner portion of the airbag 14 into the first inflation chamber 25 and the second inflation chamber 26 when the airbag 14 is inflated. In this case, a space below the partition portion 27 in the airbag 14 is taken as the first inflation chamber 25, and a space above the partition portion 27 in the airbag 14 is taken as the second inflation chamber 26. The partition portion 27 is formed with a plurality of (three pairs, that is, six in this example) circular communication holes 28 that are spaced apart from each other in a longitudinal direction thereof. The first inflation chamber 25 and the second inflation chamber 26 are in communication with each other through the communication holes 28.

In a position in the vicinity of the bend line L in the first inflation chamber 25 of the airbag 14, an opening 29 through which the inside and outside of the airbag 14 are communicated is formed by not sewing up folded and overlapped parts of the base fabric 23 therein. Further, the retainer 17 in a state where the inflator 15 is fixed is inserted into the airbag 14 from the opening 29. Accordingly, the inflator 15 is disposed in the first inflation chamber 25 of the airbag 14.

A vent hole 30 for discharging gas in the airbag 14 to the outside is formed at a front end portion of a lower end portion of the airbag 14, that is, at a front end portion of a lower end portion of the first inflation chamber 25.

As illustrated in FIGS. 1 and 5, the first inflation chamber 25 corresponds to a waist portion and a rear chest portion, which is a rear side portion of the chest portion of the occupant P, when the airbag is inflated. On the other hand, the second inflation chamber 26 corresponds to the head portion and a front chest portion, which is a front side portion of the chest portion of the occupant P, when the airbag 14 is inflated. An upper portion of the second inflation chamber 26 protrudes forward so as to reliably protect the head portion of the occupant P.

The partition portion 27 of the tether 24 includes a first linear portion 31, a second linear portion 32, a curved portion 33, and a third linear portion 34. The first linear portion 31 extends linearly in a vehicle front-rear direction, and partitions a portion corresponding to the head portion of the occupant P in the airbag 14 and a portion corresponding to the rear chest portion of the occupant P in the airbag 14. The second linear portion 32 extends linearly in an upper-lower direction, and partitions a portion corresponding to the front chest portion of the occupant P in the airbag 14 and the portion corresponding to the rear chest portion of the occupant P in the airbag 14.

The curved portion 33 extends in a curved manner to bulge out obliquely upward to the front so as to connect a front end of the first linear portion 31 and an upper end of the second linear portion 32. The third linear portion 34 extends linearly from a lower end of the second linear portion 32 to a peripheral edge portion on a front side of the airbag 14 and is directed obliquely downward to the front, and partitions the portion corresponding to the front chest portion of the occupant P in the airbag 14 and a portion corresponding to the waist portion of the occupant P in the airbag 14.

A non-inflation portion 35 not inflating is provided at a position that is in a peripheral edge portion on the front side of the airbag 14 and that faces the curved portion 33 in the vehicle front-rear direction. That is, the non-inflation portion 35 is provided at a lower end portion of a portion projecting forward in the second inflation chamber 26 of the airbag 14. The non-inflation portion 35 is formed so as to have a substantially semicircular shape by sewing up parts of the base fabric 23, which are folded and overlapped in the thickness direction of the airbag 14, in a substantially circular arc shape bulging out obliquely upward to the rear. Therefore, the inflation gas supplied from the inflator 15 into the airbag 14 does not enter the non-inflation portion 35 having a substantially semicircular shape in the airbag 14.

Next, operations of the side airbag device 11 will be described.

When impact based on a side collision is applied to the vehicle, inflation gas from the inflator 15 is supplied to the airbag 14 folded inside the seatback 13 of the seat 12, and the airbag 14 is deployed and inflated. In this case, since the inflator 15 is disposed in the first inflation chamber 25, the first inflation chamber 25 is first deployed and inflated under pressure of the inflation gas injected from the inflator 15.

Thereafter, inflation gas is supplied from the first inflation chamber 25 to the second inflation chamber 26 through the communication holes 28 of the tether 24, and the second inflation chamber 26 is deployed and inflated under the pressure of the gas. Accordingly, when the airbag 14 is inflated, the pressure of the first inflation chamber 25 corresponding to the rear chest portion and the waist portion of the occupant P is higher than the pressure of the second inflation chamber 26 corresponding to the front chest portion and the head portion of the occupant P.

In general, since the chest front portion of the occupant P includes the rib, the heart, and the like and the head portion of the occupant P includes the brain, the front chest portion and the head portion of the occupant P have relatively low resistance to impact; since the rear chest portion of the occupant P includes the shoulder and the waist portion of the occupant P includes the pelvis, both the rear chest portion and the waist portion of the occupant P have relatively high resistance to impact.

Therefore, the front chest portion and the head portion of the occupant P having relatively low resistance to impact are softly restrained and protected by the second inflation chamber 26 having a lower pressure than the first inflation chamber 25; the rear chest portion and the waist portion of the occupant P having relatively high resistance to impact are securely restrained and protected by the first inflation chamber 25 having a higher pressure than the second inflation chamber 26. As a result, the occupant P is effectively protected.

According to the embodiment described above in detail, the following effects are exhibited.

(1) In the side airbag device 11, the tether 24 partitions the inner portion of the airbag 14 into the first inflation chamber 25 and the second inflation chamber 26, and has the communication holes 28 through which the first inflation chamber 25 and the second inflation chamber 26 are in communication. Further, the first inflation chamber 25 corresponds to the rear chest portion and the waist portion of the occupant P when the airbag 14 is inflated, the second inflation chamber 26 corresponds to the front chest portion and the head portion of the occupant P when the airbag 14 is inflated, and the inflator 15 is disposed in the first inflation chamber 25. According to this configuration, since the inflator 15 is disposed in the first inflation chamber 25, when the airbag 14 is inflated, the pressure of the second inflation chamber 26 is lower than that of the first inflation chamber 25. Therefore, impact applied to the occupant P from the airbag 14 is smaller in the front chest portion and the head portion having relatively low resistance to impact than in the rear chest portion and the waist portion having relatively high resistance to impact. Accordingly, the front chest portion and the head portion having relatively low resistance to impact can be softly restrained and protected by the airbag 14 as compared with the rear chest portion and the waist portion having relatively high resistance to impact, and thus the occupant P can be effectively protected.

(2) In the side airbag device 11, the tether 24 has the partition portion 27 that partitions the inner portion of the airbag 14 into the first inflation chamber 25 and the second inflation chamber 26. Further, the partition portion 27 includes the first linear portion 31, which extends in the vehicle front-rear direction and partitions the portion corresponding to the head portion and the portion corresponding to the rear chest portion of the occupant P in the airbag 14, the second linear portion 32, which extends in the upper-lower direction and partitions the portion corresponding to the front chest portion and the portion corresponding to the rear chest portion of the occupant P in the airbag 14, and the curved portion 33, which extends in a curved manner so as to connect the front end of the first linear portion 31 and the upper end of the second linear portion 32. According to this configuration, when the airbag 14 is inflated, a thickness of a portion corresponding to the partition portion 27 of the tether 24 in the airbag 14 is thinner than those of other portions. Therefore, impact applied to the occupant P from the airbag 14 is smaller in a portion of the occupant P corresponding to the partition portion 27 of the tether 24 than in a portion of the occupant P not corresponding to the partition portion 27 of the tether 24. In this case, in particular, since the curved portion 33 and the second linear portion 32 in the partition portion 27 of the tether 24 correspond to an upper arm of the occupant P, a pressing force applied to the front chest portion, which has relatively low resistance to impact, from the upper arm of the occupant P due to the impact at the time the airbag 14 is inflated can be reduced.

(3) In the side airbag device 11, the non-inflation portion 35 not inflating is provided at the position that is in the peripheral edge portion on the front side of the airbag 14 and that faces the curved portion 33 in the vehicle front-rear direction. According to this configuration, when the airbag 14 is inflated, the portion corresponding to the head portion of the occupant P in the airbag 14 can be pulled by the non-inflation portion 35 so that the portion corresponding to the head portion of the occupant P in the airbag 14 is not excessively swung in the vehicle width direction, and thus the head portion of the occupant P can be appropriately protected.

(Modification)

The above-described embodiment can be modified as follows. In addition, the above-described embodiment and the following modification can be implemented in combination with each other without technical contradiction.

The non-inflating portion 35 may not be provided.

The airbag 14 may be configured to be deployed and inflated to correspond to a portion from the head portion to the chest portion of the occupant P. That is, the airbag 14 may not protect the waist portion of the occupant P.

The number, position, shape, and size of the communication holes 28 formed in the partition portion 27 of the tether 24 may be changed as appropriate.

What is claimed is:

1. Aside airbag device including an airbag that is to be deployed and inflated between a body side portion of a vehicle and an occupant seated on a seat in a vehicle interior under pressure of a gas supplied from an inflator, wherein
the airbag is to be deployed and inflated to correspond to a portion from at least a head portion to a chest portion of the occupant,
with a vehicle width direction being taken as a thickness direction, inner surfaces of the airbag in the thickness direction are connected by a tether so that a thickness of the airbag is regulated,
the tether partitions an inner portion of the airbag into a first inflation chamber and a second inflation chamber, and has a communication hole through which the first inflation chamber and the second inflation chamber are in communication,
the first inflation chamber corresponds to a rear chest portion when the airbag is inflated which is a rear side portion of the chest portion of the occupant,
the second inflation chamber corresponds to the head portion and a front chest portion, which is a front side portion of the chest portion of the occupant, when the airbag is inflated, and
the inflator is disposed in the first inflation chamber.

2. The side airbag device according to claim 1, wherein
the airbag is to be deployed and inflated to correspond to a portion from the head portion to a waist portion of the occupant, and
the first inflation chamber corresponds to the rear chest portion of the occupant and the waist portion of the occupant when the airbag is inflated.

3. The side airbag device according to claim 1, wherein
the tether has a partition portion that partitions the inner portion of the airbag into the first inflation chamber and the second inflation chamber, and
the partition portion includes
a first linear portion that extends in a vehicle front-rear direction and partitions a portion corresponding to the head portion of the occupant in the airbag and a portion corresponding to the rear chest portion of the occupant in the airbag,
a second linear portion that extends in an upper-lower direction and partitions a portion corresponding to the front chest portion of the occupant in the airbag and the portion corresponding to the rear chest portion of the occupant in the airbag, and
a curved portion that extends in a curved manner so as to connect a front end of the first linear portion and an upper end of the second linear portion.

4. The side airbag device according to claim 3, wherein
a non-inflation portion not inflating is provided at a position that is in a peripheral edge portion on a front side of the airbag and that faces the curved portion in the vehicle front-rear direction.

5. The side airbag device according to claim 2, wherein
the tether has a partition portion that partitions the inner portion of the airbag into the first inflation chamber and the second inflation chamber, and
the partition portion includes
a first linear portion that extends in a vehicle front-rear direction and partitions a portion corresponding to the head portion of the occupant in the airbag and a portion corresponding to the rear chest portion of the occupant in the airbag,
a second linear portion that extends in an upper-lower direction and partitions a portion corresponding to the front chest portion of the occupant in the airbag and the portion corresponding to the rear chest portion of the occupant in the airbag, and
a curved portion that extends in a curved manner so as to connect a front end of the first linear portion and an upper end of the second linear portion.

6. The side airbag device according to claim 5, wherein
a non-inflation portion not inflating is provided at a position that is in a peripheral edge portion on a front side of the airbag and that faces the curved portion in the vehicle front-rear direction.
